(19) United States
(12) Patent Application Publication
(10) Pub. No.: US 2024/0122382 A1
(43) Pub. Date: Apr. 18, 2024

(54) PRIVACY PANEL

(71) Applicant: James D. McLennan, Prospect Heights, IL (US)

(72) Inventor: James D. McLennan, Prospect Heights, IL (US)

(21) Appl. No.: 17/968,520

(22) Filed: Oct. 18, 2022

(51) Int. Cl. A47G 5/02

(52) U.S. Cl. CPC A47G 5/02; B60R 2011/004

(57) ABSTRACT

A device and method for temporarily establishing privacy at a scene, such as an accident site. An arm is removably mounted with respect to a base. A panel is movably mounted with respect to the arm to visually black the scene or accident site. A stand is removably mountable with respect to a surface, such as a ground surface. The panel is removably attachable to the stand. The panel can be moved between a closed position visually blocking the scene or accident site and an open position visually unblocking the scene or accident site.

### BACKGROUND OF THE INVENTION

### Field of the Invention

This invention relates to a privacy panel that can be quickly and easily assembled and disassembled at a scene, such as an accident site, particularly to reduce vehicle traffic congestion and provide vehicular safety to vehicles passing by the scene or accident site.

### Discussion of Related Art

Some conventional or known apparatuses and devices are constructed to obstruct or hide an environment. For example, some apparatuses and devices are constructed in a manufacturing facility and used to shelter or hide a worker from other people, such as for safety reasons. For example, some welders in a manufacturing facility construct a temporary or permanent structure to allow the welder to work within a dangerous environment and also provide safety to other workers.

### SUMMARY OF THE INVENTION

The device and method of this invention can be used to significantly reduce gapers block and improve vehicle safety of traffic flowing by a scene, such as an accident site. Often, the scene or accident site lasts for a relatively short amount of time and safety workers attend to and clean the scene or accident site. However, even during this relatively short time period, there are significant traffic jams that can occur, particularly on high-speed highways, and vehicles passing by the scene or accident site can be distracted and cause an accident of their own vehicle.

There is an apparent need for a device and method that can be quickly and easily assembled and disassembled at the scene or accident site and that provides sufficient viewing blockage of the scene or accident site.

In some embodiments of this invention, the device and method for temporarily establishing privacy at the scene or vehicle site includes a panel or screen that can be easily moved between a closed position visually blocking the scene or accident site and an open position visually unblocking the scene or accident site.

### BRIEF DESCRIPTION OF THE DRAWINGS

This invention is explained in greater detail below in view of exemplary embodiments shown in the drawings, wherein:

FIG. 1 is a perspective view of a device for establishing privacy including a panel and an arm attached to a vehicle, according to one embodiment of this invention;

FIG. 2 is a perspective view of a device for establishing privacy including a panel and a stand attached to a surface, according to one embodiment of this invention;

FIG. 3 is a perspective view of a device for establishing privacy including a panel and an arm attached to a vehicle, according to one embodiment of this invention;

FIG. 4 is a perspective view of a device for establishing privacy including a panel and an arm attached to a vehicle, according to one embodiment of this invention;

FIG. 5 is a perspective view of a device for establishing privacy including a panel and a stand, according to one embodiment of this invention; and

FIG. 6 is a perspective view of a device for establishing privacy including a panel, an arm attached to a vehicle, and a stand, according to one embodiment of this invention.

### DESCRIPTION OF PREFERRED EMBODIMENTS

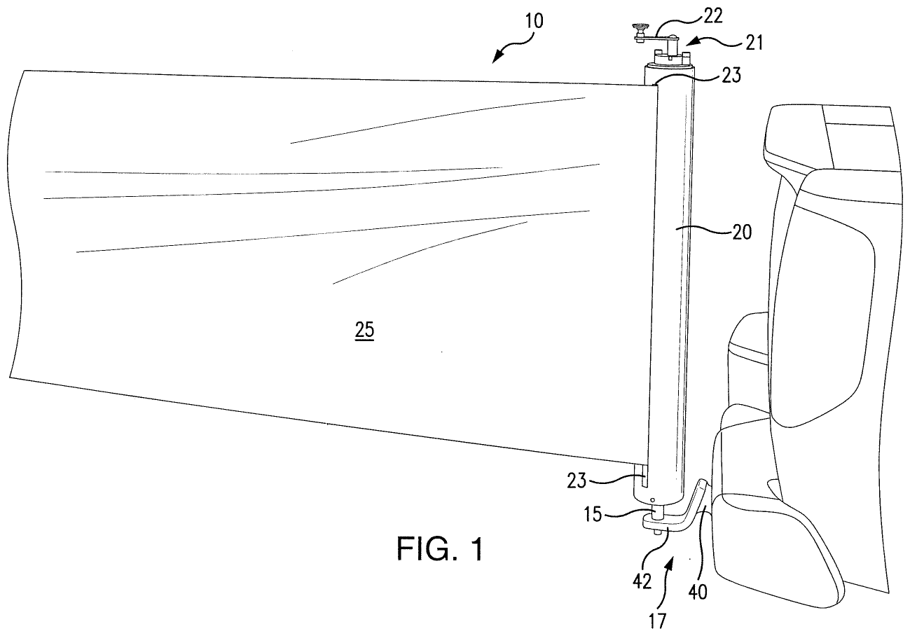

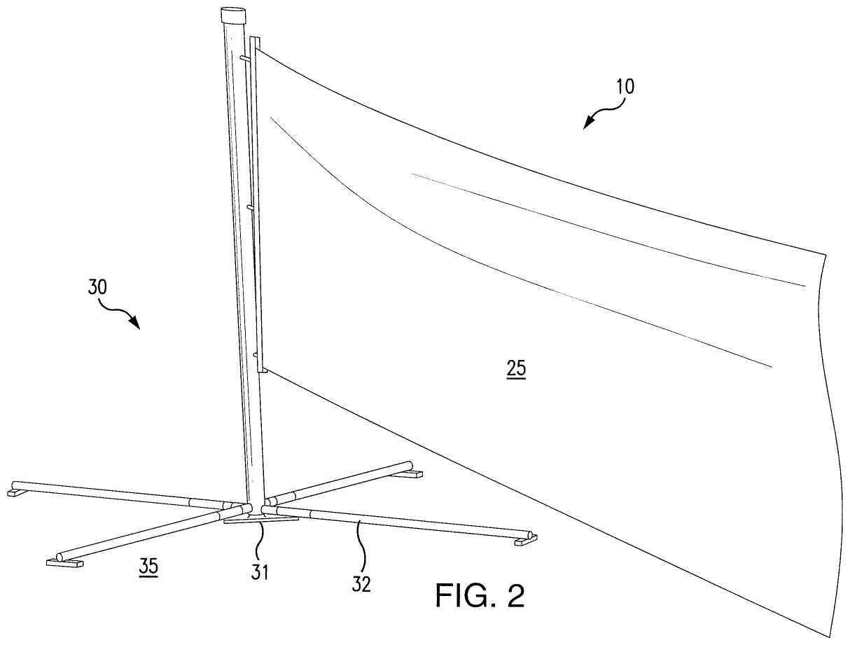

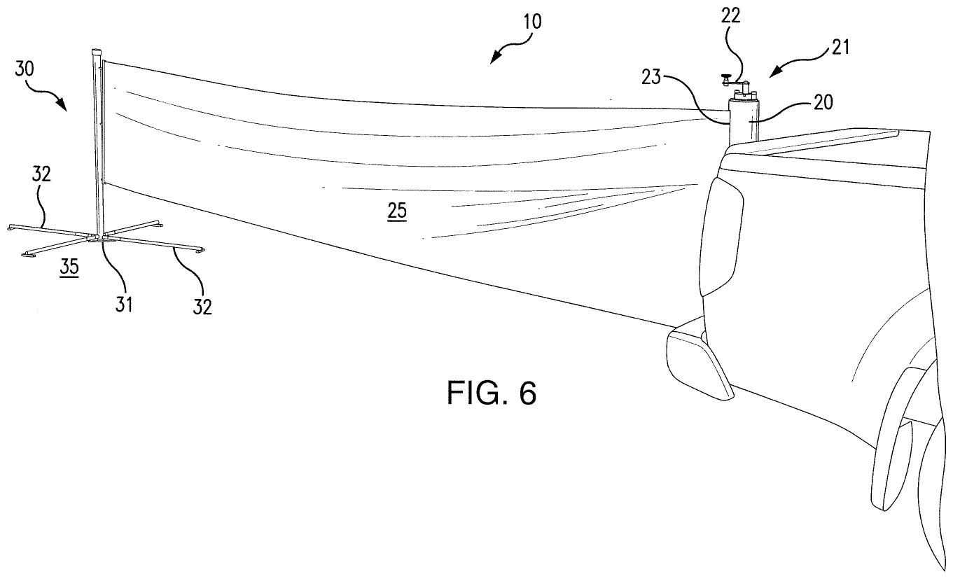

FIG. 1 shows a perspective view of base 15, arm 20 and panel 25 of device 10, for temporarily establishing privacy at a scene, according to one embodiment of this invention. FIG. 2 shows a perspective view of stand 30 and panel 25, according to one embodiment of this invention. FIG. 6 shows a perspective view of the entire device 10, including base 15, arm 20, panel 25 and stand 30, according to one embodiment of this invention.

As shown in FIG. 6, according to some embodiments of this invention, panel 25 can be quickly and easily assembled and then later disassembled to establish and then quickly remove a visual barrier and thus provide privacy and/or hide a scene, such as an accident site. As shown in FIG. 6, the scene or accident site could be behind or at a rear portion of panel 25. In some embodiments of this invention, for example, a police car and/or another emergency vehicle could arrive at an accident scene and then quickly and easily construct and/or erect all structures holding panel 25, in order to hide the accident scene. This could significantly reduce accident gawking or gapers blocks and thereby reduce unnecessary traffic jams and/or vehicle accidents caused by motorists passing by an accident scene.

According to some embodiments of this invention, panel 25 can have dimensional proportions such as shown in FIG. 6. In other embodiments of this invention, panel 25 can have any suitable size and/or shape that sufficiently covers the scene and/or accident site. In some embodiments of this invention, panel 25 is constructed or made of a flexible material that provides no transparency or sufficient transparency and/or blocking qualities, for example, so that it is possible to not see through panel 25, which would visually block the scene and/or accident site.

According to some embodiments of this invention, panel 25 is constructed of a material that is flexible and can be rolled up, such as within arm 20. In some embodiments of this invention, panel 25 is constructed of a durable material, such as a polypropylene material, a fabric material, a composite material and/or any other suitable material that can visually block the scene or accident site. Panel 25 constructed of a relatively durable material would allow panel 25 to have a relatively long useful life.

FIGS. 1, 2 and 6 show some embodiments of this invention in which panel 25 is assembled and disassembled between a vehicle, such as a motor and/or emergency vehicle, and stand 30. In other embodiments of this invention, panel 25 is assembled and disassembled between 2 vehicles or between 2 stands 30. In some embodiments of this invention, the particular mechanical structure supporting panel 25 can be selected for relatively quick and easy assembly and disassembly, such as at the scene or accident site.

According to some embodiments of this invention, panel 25 can include any suitable text and/or graphics applied to an outside surface of panel 25, for example, so that a message can be visually displayed on the outside surface of panel 25. Any suitable text and/or graphics can include printed letters, adhesive letters, painted letters and/or any other suitable attachment of the text and/or graphics. For example, in some embodiments of this invention, the text and/or graphics could read KEEP MOVING or PROCEED WITH CAUTION or any other suitable phrase, particularly that would promote the safety of drivers passing by the scene or accident site. In some embodiments of this invention, panel 25 could have any suitable color that promotes safety at the scene or accident site.

In some embodiments of this invention, panel 25, arm 20 and/or stand 30 can be constructed of relatively expensive materials that could provide longevity and several reuses of panel 25 and its corresponding structures. In other embodiments of this invention, panel 25, arm 20 and/or stand 30 can be constructed of relatively inexpensive materials that may not last as long but would provide a lower overall cost of device 10 according to this invention.

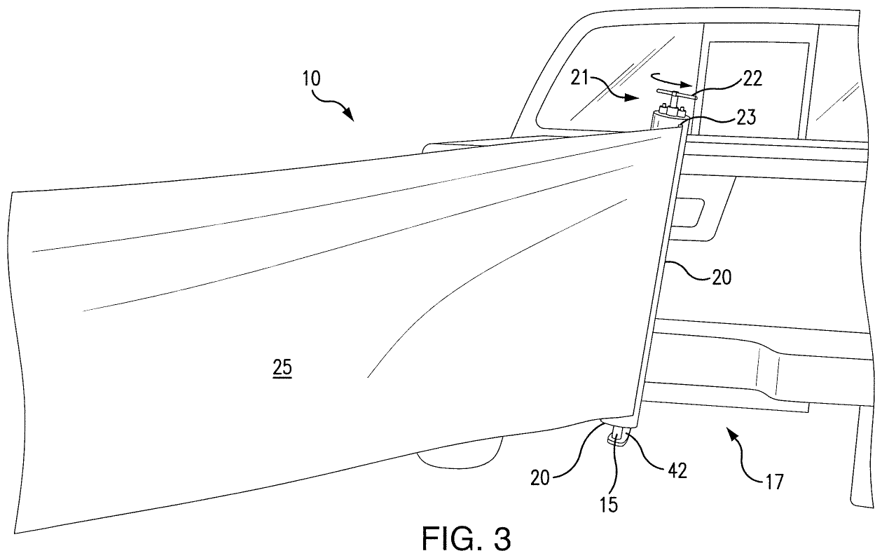

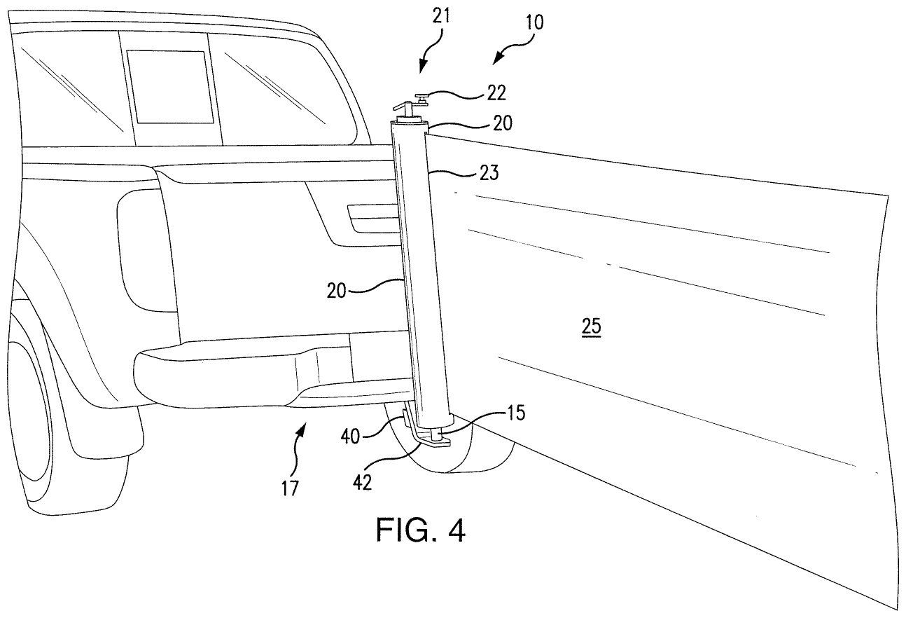

According to some embodiments of this invention, device 10 temporarily establishes privacy at the scene or vehicle site. In some embodiments of this invention, base 15, such as shown in FIGS. 1, 3 and 4, is attached to, connected to and/or otherwise fixed in position directly to or with respect to a vehicle, such as an emergency vehicle. FIGS. 1, 3 and 4 show base 15 removably attached to flange 42 of hitch 40, according to some embodiments of this invention. In some embodiments of this invention, FIGS. 1, 3 and 4 show base 15 secured with respect to fixed surface 17 which can be any suitable element and/or fixed structure. In other embodiments, base 15 can be attached to, connected to and/or otherwise fixed in position to any other suitable structure that at least temporarily remains in a fixed position, until the scene or accident site is removed and device 10 is disassembled and moved to another location.

According to some embodiments of this invention, arm 20 is removably mounted with respect to base 15, such as shown in FIGS. 1, 3 and 4. As shown in FIG. 1, base 15 can have a smaller diameter shaft extending through flange 42 of hitch 40, and in some embodiments of this invention, the smaller diameter shaft can be externally threaded to accommodate a corresponding internally threaded nut, for example, to tighten and/or otherwise secure arm 20 with respect to fixed surface 17 in order to releasably secure arm 20 with respect to fixed surface 17 and/or the vehicle as shown in FIGS. 1, 3 and 4. In other embodiments of this invention, arm 20 can be connected to, attached to and/or otherwise fixed in position with respect to the vehicle and/or any other suitable fixed structure, such as a ground surface. In some embodiments of this invention, arm 20 remains in a relatively fixed position so that rotatable mechanism 21 can be operated, for example, to move panel 25 with respect to arm 20.

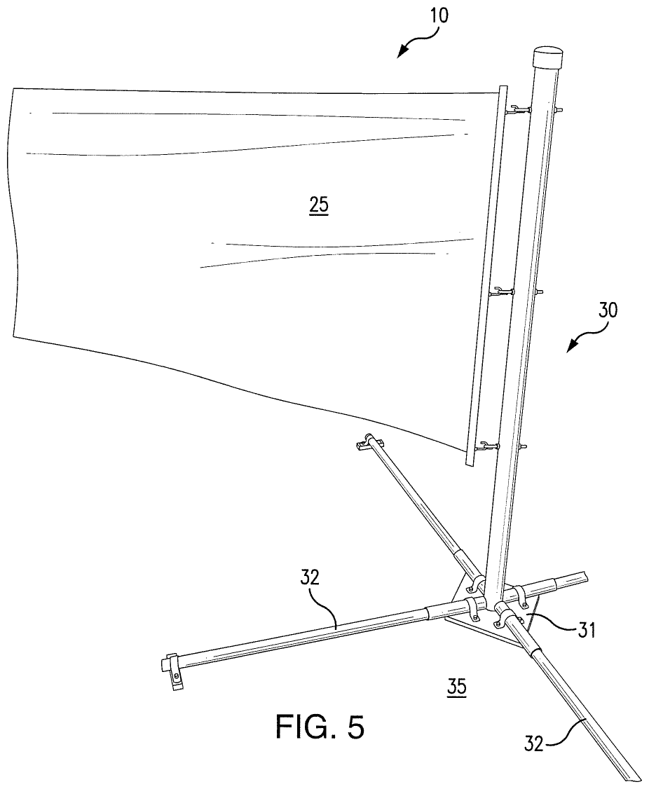

According to some embodiments of this invention, panel 25 is movably mounted with respect to arm 20 to visually block the scene or accident site. In some embodiments of this invention, stand 30 is removably mountable with respect to surface 35, such as shown in FIGS. 2, 5 and 6. In some embodiments of this invention, surface 35 is a ground surface, such as an earth surface. In other embodiments of this invention, surface 35 is a surface on a structure, device and/or other suitable apparatus that can have a relatively fixed position while panel 25 is in use.

In some embodiments of this invention, panel 25 is removably attachable to stand 30. FIGS. 2, 5 and 6 show panel 25 attached to an elongated support with 3 hooks that attach to corresponding rings on stand 30 which allows for a relatively quick and easy attachment and detachment of an end portion of panel 25 directly to or with respect to stand 30. In other embodiments of this invention, panel 25 can have any other suitable connection, attachment and/or other securement of panel 25 with respect to stand 30.

In some embodiments of this invention, panel 25 is movable between a closed position visually blocking the scene or accident site where panel 25 is attached to arm 20, and an open position visually unblocking the scene or accident site where panel 25 is detached from or with respect to stand 30. According to some embodiments of this invention, in the open position at least a portion of panel 25 is housed within cavity or opening 23 formed by arm 20. FIGS. 1, 3 and 4 clearly show atm 20 including or having opening 23 which can have the shape shown or can have any other suitable shape that allows panel 25 to move and/or pass through opening 23 and into a void formed by arm 20 in any suitable manner. In some embodiments of this invention, in the open position, at least a portion of panel 25 is housed or positioned within the void formed by arm 20. The void formed by arm 20 can have any suitable shape and/or design that accommodates movement of panel 25 into and out of the void formed by arm 20.

In some embodiments of this invention, as shown in FIGS. 1, 3, 4 and 6, rotatable mechanism 21 is used to move panel 25 into and out of the void formed by arm 20. According to some embodiments of this invention, rotatable mechanism 21 includes lever 22 rotatable with respect to arm 20 to move panel 25 between the closed position visually blocking the scene where panel 25 is attached to arm 20 and stand 30, and the open position visually unblocking the scene or accident site where panel 25 is detached from stand 30 and at least partially housed within the void formed by arm 20. In other embodiments of this invention, any other suitable device and/or structure can be used in place of rotatable mechanism 21 to accomplish the same result of moving panel 25 with respect to arm 20.

According to some embodiments of this invention, as shown in FIGS. 2, 5 and 6, stand 30 includes stand base 31 secured with respect to stand arm 32 and panel 25 is removably attached to stand 30. As shown in FIGS. 2, 5 and 6, in some embodiments of this invention, stand arm 32 is connected, attached and/or otherwise secured with respect to stand base 31. In some embodiments of this invention, stand arm 32 is rigid and one elongated piece and in other embodiments of this invention, stand arm 32 can have a telescopic feature to provide more adjustability of stand arm 32.

As shown in FIGS. 2, 5 and 6, stand 30 includes an elongated upright member connected to, attached to and/or otherwise secured with respect to base 31, in any suitable manner. In some embodiments of this invention, stand 30 includes any other suitable device and/or structure that accomplishes the same result of fixing a relative position of panel 25 with respect to surface 35.

According to some embodiments of this invention, a method for establishing privacy at the scene or accident site includes removably mounting arm 20 with respect to base 15, and movably mounting panel 25 with respect to arm 20 to visually block the scene or accident site. The method can also include removably mounting stand 30 with respect to surface 35 and removably attaching panel 25 directly to or with respect to stand 30.

While in the foregoing detailed description this invention has been described in relation to certain preferred embodiments thereof, and many details have been set forth for purposes of illustration, it will be apparent to those skilled in the art that this invention is susceptible to additional embodiments and that certain of the details described herein can be varied considerably without departing from the basic principles of this invention.

What is claimed is:

1. A device for temporarily establishing privacy at a scene, the device comprising:
a base, an arm removably mounted with respect to said base;
a panel movably mounted with respect to said arm to visually block the scene; and
a stand removably mountable with respect to a surface, and said panel removably attachable to said stand.

2. The device according to claim 1, wherein said base is removably attached to a flange of a vehicle hitch.

3. The device according to claim 1, wherein said base is secured with respect to a fixed surface.

4. The device according to claim 1, wherein said panel is moveable between a closed position visually blocking the scene where said panel is attached to said arm and said stand, and an open position visually unblocking the scene where said panel is detached from said stand.

5. The device according to claim 4, wherein in the open position at least a portion of said panel is housed within said arm.

6. The device according to claim 1, wherein said panel is housed within said arm.

7. The device according to claim 1, wherein said stand comprises a stand base secured with respect to a stand arm and said panel is removably attached to said stand arm.

8. The device according to claim 1, wherein a rotatable mechanism comprises a lever rotatable with respect to said arm to move said panel between a closed position visually blocking the scene where said panel is attached to said arm and said stand and an open position visually unblocking the scene where said panel is detached from said stand and at least partially housed within said arm.

9. The device according to claim 1, wherein said arm forms a void and at least a portion of said panel is housed within said void.

10. A device for establishing privacy at a scene, the device comprising:
a base, an arm removably mounted with respect to said base;
a panel moveable with respect to said arm to visually block the scene; and
a stand removably mounted to a surface, and said panel removably attachable to said stand.

11. The device according to claim 10, wherein said base is mounted to a fixed surface.

12. The device according to claim 10, wherein said panel moves between a closed position visually blocking the scene where said panel is attached to said arm and said stand, and an open position visually unblocking the scene where said panel is detached from said stand.

13. The device according to claim 12, wherein in the open position at least a portion of said panel is housed within said arm.

14. The device according to claim 10, wherein said stand comprises a stand base secured with respect to a stand arm and said panel is removably attached to said stand arm.

15. The device according to claim 10, wherein a rotatable mechanism comprises a lever rotatably mounted to said arm to move said panel between a closed position visually blocking the scene where said panel is attached to said arm and said stand and an open position visually unblocking the scene where said panel is detached from said stand and at least partially housed within said arm.

16. A method for establishing privacy at a scene, the method including the steps of:
removably mounting an arm with respect to a base;
movably mounting a panel with respect to said arm to visually block the scene;
removably mounting a stand with respect to a surface; and
removably attaching said panel to said stand.

17. The method according to claim 16, wherein said panel is moveable between a closed position visually blocking the scene where said panel is attached to said arm and said stand, and an open position visually unblocking the scene where said panel is detached from said stand.

18. The method according to claim 17, wherein in the open position at least a portion of said panel is housed within said arm.

19. The method according to claim 16, wherein said stand comprises a stand base secured with respect to a stand arm and said panel is removably attached to said stand arm.

20. The method according to claim 16, wherein a rotatable mechanism comprises a lever rotatable with respect to said arm to move said panel between a closed position visually blocking the scene where said panel is attached to said arm and said stand and an open position visually unblocking the scene where said panel is detached from said stand and at least partially housed within said arm.
